(19) United States
(12) Patent Application Publication
(10) Pub. No.: US 2012/0328960 A1
(43) Pub. Date: Dec. 27, 2012

(54) NONAQUEOUS SOLVENT AND POWER STORAGE DEVICE

(75) Inventors: Kyosuke ITO, Hadano (JP); Toru Itakura, Fujisawa (JP)

(73) Assignee: SEMICONDUCTOR ENERGY LABORATORY CO., LTD., Atsugi-shi (JP)

(21) Appl. No.: 13/527,642

(22) Filed: Jun. 20, 2012

(30) Foreign Application Priority Data
Jun. 24, 2011 (JP) 2011-140733

(51) Int. Cl. C09K 5/10; H01G 9/035; H01M 10/056

(52) U.S. Cl. 429/336; 429/339; 361/505; 252/77

(57) ABSTRACT

A nonaqueous solvent having excellent reduction resistance, which can be applied to an electrolyte solution, is provided. Further, a nonaqueous solvent which can be used in a wide temperature range and applied to an electrolyte solution is provided. Furthermore, a high-performance power storage device is provided. A nonaqueous solvent containing at least an ionic liquid including an alicyclic quaternary ammonium cation having one or more substituents and a counter anion to the alicyclic quaternary ammonium cation, and a freezing-point depressant is provided. A power storage device including the nonaqueous solvent for an electrolyte solution is also provided.

### BACKGROUND OF THE INVENTION

1. Field of the Invention

The present invention relates to a nonaqueous solvent including an ionic liquid and a power storage device including the nonaqueous solvent.

Note that the power storage device indicates all elements and devices which have a function of storing power.

2. Description of the Related Art

A lithium-ion secondary battery which is one of power storage devices is used in a variety of applications including mobile phones, electric vehicles (EV), and the like. Characteristics such as high energy density, an improvement in cycle characteristics, safety under a variety of operating environments, and the like are necessary for a lithium-ion secondary battery.

Many of electrolyte solutions for lithium-ion secondary batteries are compounds containing a nonaqueous solvent and an electrolyte salt including a lithium ion. An organic solvent often used as the nonaqueous solvent includes cyclic carbonate such as ethylene carbonate having high dielectric constant and excellent ion conductivity.

However, not only ethylene carbonate but many organic solvents have volatility and a low flash point. For this reason, in the case where an organic solvent is used as a nonaqueous solvent contained in an electrolyte solution for a lithium-ion secondary battery, the temperature inside the lithium-ion secondary battery might rise owing to a short circuit, overcharge, or the like and the lithium-ion secondary battery might burst or catch fire.

In view of the above, it has been considered to use a room temperature molten salt (also referred to as an ionic liquid) which is less likely to burn and volatilize for a nonaqueous solvent contained in an electrolyte solution for a lithium-ion secondary battery.

When an ionic liquid is used for a nonaqueous solvent contained in an electrolyte solution for a lithium-ion secondary battery, there is a problem in that a low potential negative electrode material cannot be used because of low reduction resistance of an ionic liquid. Thus, a technique has been disclosed, which enables dissolution and precipitation of lithium which is a low potential negative electrode material without an additive by improving the reduction resistance of an ionic liquid including quaternary ammonium salt (see Patent Document 1).

### REFERENCE

[Patent Document 1] Japanese Published Patent Application No. 2003-331918

### SUMMARY OF THE INVENTION

However, the reduction potential of an ionic liquid whose reduction resistance is thus improved is substantially equivalent to an oxidation-reduction potential of lithium. Further improvement is required for the reduction resistance of an ionic liquid.

In view of the above problem, an object of one embodiment of the present invention is to provide a nonaqueous solvent having excellent reduction resistance, which can be applied to an electrolyte solution.

Since an ionic liquid is less likely to burn and volatilize, it can be said that the ionic liquid is advantageous when used at high temperatures. However, a power storage device is needed to operate normally not only in a high-temperature environment at temperatures higher than normal temperature (or room temperature) (approximately higher than or equal to normal temperature and lower than or equal to 70° C.) but also in a low-temperature environment at temperatures lower than normal temperature (approximately higher than or equal to −30° C. and lower than or equal to normal temperature). Thus, an electrolyte solution included in the power storage device is needed to have a low freezing point.

For example, a melting point of an ionic liquid including a quaternary ammonium-based cation in Patent Document 1 is approximately 10° C.; thus, in the case where a power storage device including the ionic liquid for an electrolyte solution is used in the low-temperature environment, the ionic liquid might be coagulated and the resistance of the ionic liquid might be increased. In addition, a problem in that the range of operating temperature of the power storage device is narrowed occurs because it is difficult to use the power storage device in the low-temperature environment.

Accordingly, an object of one embodiment of the present invention is to provide a nonaqueous solvent which can be used in a wide temperature range and applied to an electrolyte solution. Another object is to provide a high-performance power storage device.

In view of the above problems, one embodiment of the present invention is a nonaqueous solvent containing at least an ionic liquid including an alicyclic quaternary ammonium cation having one or more substituents and a counter anion to the alicyclic quaternary ammonium cation, and a freezing-point depressant.

The ionic liquid contained in the nonaqueous solvent may be a compound in which the substituent is bonded to an aliphatic ring of the alicyclic quaternary ammonium cation. Note that the number of carbon atoms in the aliphatic ring is preferably five or less.

In the nonaqueous solvent, the freezing-point depressant preferably has lower viscosity than the ionic liquid. Alternatively, the freezing-point depressant may be an ionic liquid including a cyclic quaternary ammonium cation and a counter anion to the cyclic quaternary ammonium cation. Further alternatively, the freezing-point depressant may be an ionic liquid including an acyclic quaternary ammonium cation and a counter anion to the acyclic quaternary ammonium cation.

Another embodiment of the present invention is a nonaqueous solvent containing at least an ionic liquid represented by a general formula (G1) and a freezing-point depressant.

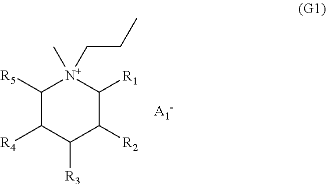

In the general formula (G1), R₁ to R₅ are individually any of a hydrogen atom, an alkyl group having 1 to 20 carbon atoms, a methoxy group, a methoxymethyl group, and a methoxyethyl group, and A₁⁻ is any of a monovalent imide anion, a monovalent methide anion, a perfluoroalkyl sulfonic acid anion, tetrafluoroborate, and hexafluorophosphate.

In the nonaqueous solvent, the freezing-point depressant preferably has lower viscosity than the ionic liquid. Alternatively, the freezing-point depressant may be an ionic liquid including a cyclic quaternary ammonium cation and a counter anion to the cyclic quaternary ammonium cation. Further alternatively, the freezing-point depressant may be an ionic liquid including an acyclic quaternary ammonium cation and a counter anion to the acyclic quaternary ammonium cation.

In the nonaqueous solvent, the freezing-point depressant may be the ionic liquid represented by the general formula (G1).

In the nonaqueous solvent, the freezing-point depressant may be an ionic liquid represented by a general formula (G2).

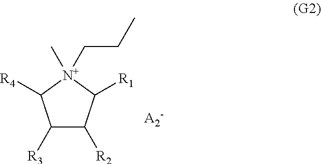

In the general formula (G2), R₁ to R₄ are individually any of a hydrogen atom, an alkyl group having 1 to 20 carbon atoms, a methoxy group, a methoxymethyl group, and a methoxyethyl group, and A₂⁻ is any of a monovalent imide anion, a monovalent methide anion, a perfluoroalkyl sulfonic acid anion, tetrafluoroborate, and hexafluorophosphate.

Another embodiment of the present invention is a power storage device including at least a positive electrode, a negative electrode, an electrolyte solution, and a separator in addition to the above nonaqueous solvent, in which the nonaqueous solvent is used for the electrolyte solution. Alternatively, a nonaqueous solvent including an electrolyte salt may be used as the electrolyte solution. Note that the electrolyte salt may be an electrolyte salt including a lithium ion.

According to one embodiment of the present invention, a nonaqueous solvent having excellent reduction resistance, which can be applied to an electrolyte solution, can be provided. Further, a nonaqueous solvent which can be used in a wide temperature range and applied to an electrolyte solution can be provided. Furthermore, a high-performance power storage device can be provided with the use of the nonaqueous solvent for an electrolyte solution.

### BRIEF DESCRIPTION OF THE DRAWINGS

In the accompanying drawings:

FIGS. 1A and 1B are cross-sectional views illustrating lithium-ion secondary batteries according to one embodiment of the present invention;

FIGS. 2A and 2B are a top view and a perspective view of a lithium-ion secondary battery according to one embodiment of the present invention;

FIGS. 3A and 3B are perspective views illustrating a manufacturing method of a lithium-ion secondary battery according to one embodiment of the present invention;

FIG. 4 is a perspective view illustrating a manufacturing method of a lithium-ion secondary battery according to one embodiment of the present invention; and

FIG. 5 is a perspective view illustrating electric appliances each including a power storage device according to one embodiment of the present invention.

### DETAILED DESCRIPTION OF THE INVENTION

Hereinafter, embodiments of the present invention will be described in detail with reference to the accompanying drawings. However, the present invention is not limited to the following description and it is easily understood by those skilled in the art that the mode and details can be variously changed without departing from the spirit and scope of the present invention. Accordingly, the present invention should not be construed as being limited to the description of the embodiments below. In describing structures of the present invention with reference to the drawings, the same reference numerals are used in common for the same portions in different drawings. The same hatching pattern is applied to similar parts, and the similar parts are not especially denoted by reference numerals in some cases. In addition, an insulating layer is not illustrated in a top view in some cases. Note that the size, the layer thickness, or the region of each structure illustrated in each drawing is exaggerated for clarity in some cases. Thus, the present invention is not necessarily limited to such scales illustrated in the drawings.

### Embodiment 1

In this embodiment, a nonaqueous solvent according to one embodiment of the present invention will be described.

The nonaqueous solvent according to one embodiment of the present invention is a nonaqueous solvent containing at least an ionic liquid including an alicyclic quaternary ammonium cation having one or more substituents and its counter anion, and a freezing-point depressant.

The ionic liquid preferably includes an alicyclic quaternary ammonium cation in which substituents having different structures are bonded to a nitrogen atom. That is, the ionic liquid preferably includes an alicyclic quaternary ammonium cation having an asymmetrical structure. An example of the substituent includes an alkyl group having 1 to 4 carbon atoms. Note that the substituent is not limited thereto and a variety of substituents can be used as long as the alicyclic quaternary ammonium cation has an asymmetrical structure.

When the alicyclic quaternary ammonium cation included in the ionic liquid has a substituent bonded to an aliphatic ring of the alicyclic quaternary ammonium cation, an advantageous effect due to an interaction with the substituent is obtained. For example, in the case where an electron donating substituent is used, inductive effects are caused and electric polarization of the alicyclic quaternary ammonium cation is alleviated owing to the inductive effects. Thus, it is difficult for the alicyclic quaternary ammonium cation to accept electrons, so that the reduction potential of the ionic liquid can be low. Note that the low reduction potential means an improvement in reduction resistance (also referred to as stability against reduction).

As examples of the electron donating substituent, an alkyl group having 1 to 20 carbon atoms, a methoxy group, a methoxymethyl group, and a methoxyethyl group, can be given. The alkyl group may be either a straight-chain alkyl group or a branched-chain alkyl group. Note that the substituent is not limited thereto as long as the substituent has an electron donating property. The substituent is not even limited to an electron donating substituent.

In the alicyclic quaternary ammonium cation included in the ionic liquid, the number of carbon atoms in the aliphatic ring is preferably five or less in view of the stability, viscosity, and ion conductivity of a compound and ease of synthesis. In other words, a quaternary ammonium cation in which the length of a ring is shorter than that of a six-membered ring is preferably used.

The anion included in the ionic liquid is a monovalent anion which forms the ionic liquid with the alicyclic quaternary ammonium cation. Examples of the anion include a monovalent imide anion, a monovalent methide anion, a perfluoroalkyl sulfonic acid anion, tetrafluoroborate (BF₄⁻), and hexafluorophosphate (PF₆⁻). As a monovalent imide anion, (CₙF₂ₙ₊₁SO₂)₂N⁻ (n=0 to 3), CF₂(CF₂SO₂)₂N⁻, and the like can be given. As a monovalent methide anion, (CₙF₂ₙ₊₁SO₂)₂C⁻ (n=0 to 3), CF₂(CF₂SO₂)₂C⁻, and the like can be given. As a perfluoroalkyl sulfonic acid anion, (CₘF₂ₘ₊₁SO₃)⁻ (m=0 to 4) and the like can be given. Note that the anion is not limited thereto as long as the anion can form the ionic liquid with the alicyclic quaternary ammonium cation.

The above ionic liquid corresponds to the general formula (G3).

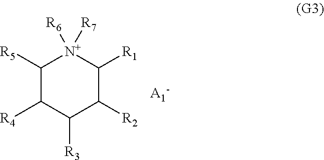

In the general formula (G3), R₁ to R₅ are individually any of a hydrogen atom, an alkyl group having 1 to 20 carbon atoms, a methoxy group, a methoxymethyl group, and a methoxyethyl group; R₆ and R₇ are individually an alkyl group having 1 to 4 carbon atoms; and A₁⁻ is any of a monovalent imide anion, a monovalent methide anion, a perfluoroalkyl sulfonic acid anion, tetrafluoroborate (BF₄⁻), and hexafluorophosphate (PF₆⁻).

When the viscosity of an electrolyte solution (in particular, the nonaqueous solvent contained in the electrolyte solution) included in a power storage device is reduced, rate characteristics (output characteristics) of the power storage device can be improved. In the case where R₁ to R₅ in the ionic liquid represented by the general formula (G3) are alkyl groups having Ito 20 carbon atoms, the number of carbon atoms is preferably small (e.g., 1 to 4) because the viscosity of the ionic liquid can be reduced, so that the viscosity of the electrolyte solution can be reduced.

The nonaqueous solvent according to one embodiment of the present invention contains the freezing-point depressant in addition to the ionic liquid. Accordingly, the freezing point of the nonaqueous solvent according to one embodiment of the present invention is lower than that of a nonaqueous solvent containing only the ionic liquid. That is, the nonaqueous solvent according to one embodiment of the present invention does not coagulate at temperatures lower than normal temperature and functions as a nonaqueous solvent contained in the electrolyte solution, so that an electrolyte solution which can be used in a wide temperature range can be fabricated. Thus, a power storage device in which the nonaqueous solvent is included in an electrolyte solution can be operated in a wide temperature range.

The freezing-point depressant is a substance (e.g., an organic salt or an inorganic salt), which can lower the freezing point of the ionic liquid by adding to the ionic liquid. Since the electrolyte solution (in particular, the nonaqueous solvent contained in the electrolyte solution) included in the power storage device is preferably less likely to burn and volatilize so that a burst, ignition, and the like do not occur at high temperatures, the freezing-point depressant is also preferably an ionic liquid. For example, an ionic liquid including an aliphatic or aromatic cyclic quaternary ammonium cation and its counter anion, and an ionic liquid including an acyclic quaternary ammonium cation and its counter anion can be used. In that case, the nonaqueous solvent according to one embodiment of the present invention contains a first ionic liquid and a second ionic liquid having different compound structures, and it can be said that the second ionic liquid functions as the freezing-point depressant.

Note that the mixture ratio of the ionic liquid and the freezing-point depressant in the nonaqueous solvent according to one embodiment of the present invention may be appropriately selected in consideration of kinds of an ionic liquid and a freezing-point depressant, which are to be used, or characteristics (viscosity, ion conductivity, and the like) needed for an electrolyte solution to be formed.

The nonaqueous solvent according to one embodiment of the present invention may contain the first ionic liquid and the second ionic liquid which are represented by the general formula (G3) and have different compound structures. In that case, it can be said that the second ionic liquid functions as the freezing-point depressant.

The freezing-point depressant may be an ionic liquid represented by the general formula (G4). In that case, the nonaqueous solvent according to one embodiment of the present invention contains the ionic liquid represented by the general formula (G3) as the first ionic liquid and the ionic liquid represented by the general formula (G4) as the second ionic liquid, and it can be said that the second ionic liquid functions as the freezing-point depressant.

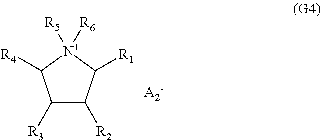

In the general formula (G4), R₁ to R₄ are individually any of a hydrogen atom, an alkyl group having 1 to 20 carbon atoms, a methoxy group, a methoxymethyl group, and a methoxyethyl group; R₅ and R₆ are individually any of an alkyl group having 1 to 4 carbon atoms; and A₂⁻ is a monovalent imide anion, a monovalent methide anion, a perfluoroalkyl sulfonic acid anion, tetrafluoroborate (BF₄⁻), and hexafluorophosphate (PF₆⁻).

Here, reduction resistance and oxidation resistance of the electrolyte solution (in particular, the nonaqueous solvent contained in the electrolyte solution) included in the power storage device will be described. The electrolyte solution (in particular, the nonaqueous solvent contained in the electrolyte solution) included in the power storage device preferably has excellent reduction resistance and oxidation resistance. In the case of low reduction resistance (also referred to as stability against reduction), the electrolyte solution (in particular, the nonaqueous solvent contained in the electrolyte solution) accepts electrons from a negative electrode, whereby the ionic liquid contained in the electrolyte solution is reduced and decomposed. As a result, characteristics of the power storage device deteriorate. “Reduction of an ionic liquid” means that an ionic liquid accepts electrons from a negative electrode. Thus, when a cation having a positive charge, which is included in the ionic liquid, is particularly made difficult to accept electrons, the reduction potential of the ionic liquid can be lowered.

Thus, the ionic liquid (the first ionic liquid) contained in the nonaqueous solvent according to one embodiment of the present invention preferably has better reduction resistance than the freezing-point depressant. Specifically, the ionic liquid (the first ionic liquid) preferably has a plurality of electron donating substituents. This is because inductive effects are caused by the electron donating substituent and electric polarization of the alicyclic quaternary ammonium cation included in the ionic liquid (the first ionic liquid) is alleviated as the number of the electron donating substituents increases, so that electrons are difficult to be accepted, and the reduction resistance of the ionic liquid tends to be improved.

Further, the reduction potential of the ionic liquid contained in the nonaqueous solvent according to one embodiment of the present invention is preferably lower than oxidation-reduction potential of lithium (Li/Li⁺), which is a typical low potential negative electrode material.

However, as the number of electron donating substituents increases, the viscosity of the ionic liquid tends to increase.

Thus, the freezing-point depressant contained in the nonaqueous solvent according to one embodiment of the present invention preferably has lower viscosity than the ionic liquid. In particular, in the case where an ionic liquid is used as the freezing-point depressant (that is, in the case where the nonaqueous solvent contains the first ionic liquid and the second ionic liquid), the viscosity of the second ionic liquid is preferably lower than that of the first ionic liquid. For example, in the case where R₁ to R₅ in the ionic liquid represented by the general formula (G4) are alkyl groups having 1 to 20 carbon atoms, the viscosity of an ionic liquid to be synthesized can be reduced with fewer carbon atoms (e.g., 1 to 4 carbon atoms). In this manner, the reduction resistance can be improved and the viscosity of the electrolyte solution (in particular, the nonaqueous solvent contained in the electrolyte solution) can be reduced to a much lower level than that of the first ionic liquid, so that a favorable electrolyte solution (in particular, the nonaqueous solvent contained in the electrolyte solution) included in the power storage device can be obtained. This is because as the viscosity of the electrolyte solution included in the power storage device is lower, the rate characteristics of the power storage device can be improved. Note that the alicyclic quaternary ammonium cation included in the ionic liquid can be easily synthesized with fewer carbon atoms in the alkyl group.

The mixture ratio of the first ionic liquid and the second ionic liquid may be appropriately selected in consideration of characteristics (viscosity, ion conductivity, and the like) needed for an electrolyte solution to be formed.

Oxidation potential of the ionic liquid changes depending on anionic species. Thus, in order to obtain an ionic liquid having high oxidation potential, the anion in the ionic liquid contained in the nonaqueous solvent according to one embodiment of the present invention is preferably a monovalent anion selected from (CₙF₂ₙ₊₁SO₂)₂N⁻ (n=0 to 3), CF₂(CF₂SO₂)₂N⁻, and (CₘF₂ₘ₊₁SO₃)⁻ (m=0 to 4). Note that the high oxidation potential means an improvement in oxidation resistance (also referred to as stability against oxidation). The oxidation resistance is improved by the interaction between a cation in which electric polarization is alleviated because of an electron donating substituent and the anion described above.

A preferable embodiment of the nonaqueous solvent according to one embodiment of the present invention is a nonaqueous solvent containing the first ionic liquid having many electron donating substituents and excellent reduction resistance and oxidation resistance but high viscosity, and the second ionic liquid having reduction resistance inferior to the first ionic liquid but low viscosity.

Although each of the ionic liquid and the freezing-point depressant contained in the nonaqueous solvent according to one embodiment of the present invention is one kind in the above description, the ionic liquid may be two or more kinds having different compound structures. In addition, the freezing-point depressant may also be two or more kinds having different compound structures.

Accordingly, when reduction resistance and oxidation resistance of the nonaqueous solvent according to one embodiment of the present invention are improved, that is, an oxidation-reduction potential window of the nonaqueous solvent is enlarged, the number of choices of positive electrode materials and negative electrode materials can be increased in a power storage device including an electrolyte solution containing the nonaqueous solvent; thus, the nonaqueous solvent is stable to a selected positive electrode material and negative electrode material. As a result, a power storage device having excellent reliability can be fabricated.

The energy density of a power storage device is caused by a difference between oxidation potential of a positive electrode material and reduction potential of a negative electrode material. Thus, a lower potential negative electrode material and a higher potential positive electrode material can be selected by using a nonaqueous solvent having a wide reduction-oxidation potential window, such as the nonaqueous solvent according to one embodiment of the present invention. Consequently, a power storage device having high energy density can be fabricated.

This embodiment can be implemented in appropriate combination with any of the structures described in the other embodiments.

### Embodiment 2

In this embodiment, the nonaqueous solvent in Embodiment 1 will be described in detail. A nonaqueous solvent described in this embodiment is a nonaqueous solvent containing at least an ionic liquid represented by the general formula (G1) and a freezing-point depressant.

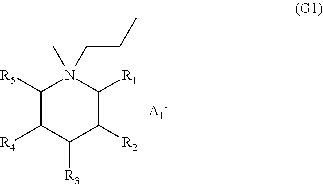

In the general formula (G1), R₁ to R₅ are individually any of a hydrogen atom, an alkyl group having 1 to 20 carbon atoms, a methoxy group, a methoxymethyl group, and a methoxyethyl group, and A₁⁻ is any of a monovalent imide anion, a monovalent methide anion, a perfluoroalkyl sulfonic acid anion, tetrafluoroborate, and hexafluorophosphate.

The general formula (G1) is the same as the general formula (G3) described in Embodiment 1 except that R₆ and R₇ in the general formula (G3) are a methyl group and a propyl group.

Further, the nonaqueous solvent described in this embodiment contains the freezing-point depressant as in Embodiment 1. Accordingly, the nonaqueous solvent has a lower freezing point than a nonaqueous solvent containing only the ionic liquid represented by the general formula (G1). That is, the nonaqueous solvent does not coagulate at temperatures lower than normal temperature and functions as a nonaqueous solvent contained in an electrolyte solution, so that an electrolyte solution which can be used in a wide temperature range can be fabricated. Thus, a power storage device in which the nonaqueous solvent is included in an electrolyte solution can be operated in a wide temperature range.

Similarly to Embodiment 1, when an aliphatic ring of an alicyclic quaternary ammonium cation in the ionic liquid has one or more electron donating substituents, reduction potential of the ionic liquid can be lowered. Thus, the reduction resistance of the ionic liquid can be improved.

As examples of the electron donating substituent, an alkyl group having 1 to 20 carbon atoms, a methoxy group, a methoxymethyl group, and a methoxyethyl group can be given. The alkyl group may be either a straight-chain alkyl group or a branched-chain alkyl group. Note that the substituent is not limited thereto and is not even limited to an electron donating substituent.

Here, the following calculation results show that the reduction potential of the ionic liquid according to one embodiment of the present invention is lowered (the reduction resistance is improved) by an interaction with the electron donating substituent.

The lowest unoccupied molecular orbital level (LUMO level) of an alicyclic quaternary ammonium cation in each of nine kinds of ionic liquids determined by a quantum chemistry computation is shown in Table 1. The nine kinds of ionic liquids each include a methyl group as any of the substituents R₁ to R₅ in the general formula (G1). The nine kinds of ionic liquids are represented by structural formulae (α-1) to (α-9) below. In addition, as a comparative example, the lowest unoccupied molecular orbital level (LUMO level) of an (N-methyl-N-propylpiperidinium) cation represented by a structural formula (α-10) below is shown in the Table 1. An (N-methyl-N-propylpiperidinium) cation is an ionic liquid having reduction potential which is the same degree as that of oxidation-reduction potential of lithium which is used for a negative electrode of a power storage device.

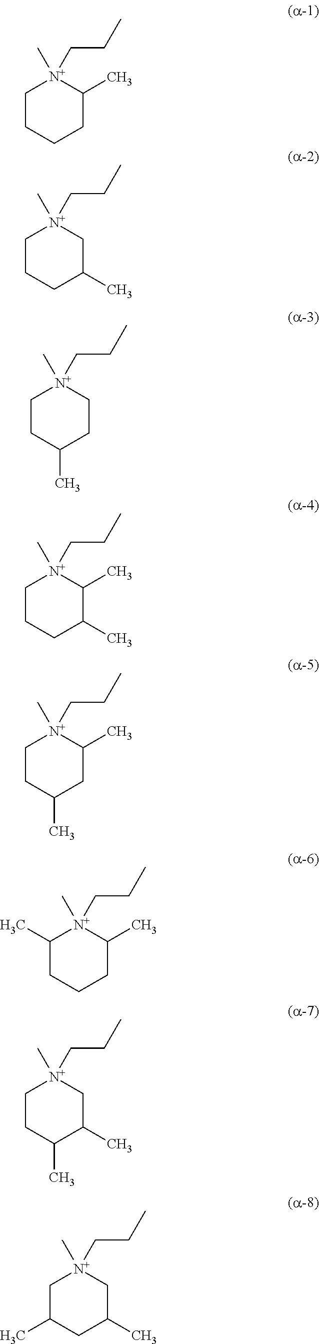

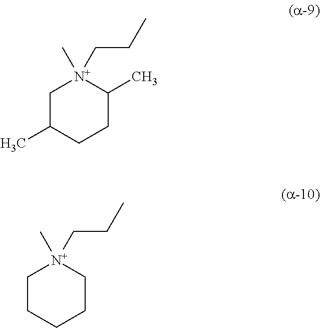

TABLE 1

| | LUMO Level |
|---|---|
| Structural Formula (α-1) | −3.047 [eV] |
| Structural Formula (α-2) | −3.174 [eV] |
| Structural Formula (α-3) | −3.192 [eV] |
| Structural Formula (α-4) | −2.941 [eV] |
| Structural Formula (α-5) | −3.013 [eV] |
| Structural Formula (α-6) | −2.877 [eV] |
| Structural Formula (α-7) | −3.125 [eV] |
| Structural Formula (α-8) | −3.102 [eV] |
| Structural Formula (α-9) | −2.970 [eV] |
| Structural Formula (α-10) | −3.244 [eV] |

In the quantum chemistry computation of this embodiment, the optimal molecular structures in the ground state and a triplet state of an alicyclic quaternary ammonium cation in each of the ionic liquids according to one embodiment of the present invention and the (N-methyl-N-propylpiperidinium) cation are calculated by using the density functional theory (DFT). In the DFT, the total energy is represented as the sum of potential energy, electrostatic energy between electrons, electronic kinetic energy, and exchange-correlation energy including all the complicated interactions between electrons. Also in the DFT, an exchange-correlation interaction is approximated by a functional (function of another function) of one electron potential represented in terms of electron density to enable highly accurate calculations. Here, B3LYP, which is a hybrid functional, is used to specify the weight of each parameter related to exchange-correlation energy. In addition, as a basis function, 6-311 (a basis function of a triple-split valence basis set using three contraction functions for each valence orbital) is applied to all the atoms. By the above basis function, for example, orbits of is to 3s are considered in the case of hydrogen atoms while orbits of is to 4s and 2p to 4p are considered in the case of carbon atoms. Further, to improve calculation accuracy, the p function and the d function as polarization basis sets are added to hydrogen atoms and atoms other than hydrogen atoms, respectively.

Note that Gaussian 09 was used as the quantum chemistry computational program. A high performance computer (Altix 4700, manufactured by SGI Japan, Ltd.) was used for the calculations. The quantum chemistry computation was performed assuming that all of the cations represented by the structural formulae (α-1) to (α-10) had the most stable structure and were in a vacuum.

In the case where the ionic liquid is used for the nonaqueous solvent in the electrolyte solution included in the power storage device, the reduction resistance of the ionic liquid according to one embodiment of the present invention depends on the degree of accepting electrons from the negative electrode of the alicyclic quaternary ammonium cation in the ionic liquid.

For example, when the LUMO level of an alicyclic quaternary ammonium cation is higher than a conduction band of a negative electrode material, an ionic liquid including the cation is not reduced. The reduction resistance of the cation with respect to lithium can be evaluated by comparing the LUMO level of the cation with the LUMO level of an (N-methyl-N-propylpiperidinium) cation having reduction potential substantially equivalent to oxidation-reduction potential of lithium that is a typical low potential negative electrode material. In other words, it can be said that when the LUMO level of an alicyclic quaternary ammonium cation in the ionic liquid according to one embodiment of the present invention is higher than the LUMO level of an (N-methyl-N-propylpiperidinium) cation, the ionic liquid according to one embodiment of the present invention is excellent in reduction resistance.

The LUMO level of the (N-methyl-N-propylpiperidinium) cation that is a comparative example represented by the structural formula (α-10) is −3.244 eV. The LUMO levels of the alicyclic quaternary ammonium cations in the ionic liquids according to one embodiment of the present invention are all higher than −3.244 eV. Thus, the ionic liquids according to one embodiment of the present invention have excellent reduction resistance. The reduction resistance is improved by an advantageous effect of an introduction of an electron donating substituent into a carbon hydrogen ring of the alicyclic quaternary ammonium cation.

Note that in the case where R₁ to R₅ in the general formula (G1) are alkyl groups having 1 to 20 carbon atoms, the viscosity of an ionic liquid to be synthesized can be reduced with fewer carbon atoms (e.g., 1 to 4 carbon atoms). Thus, a favorable electrolyte solution (in particular, the nonaqueous solvent contained in the electrolyte solution) included in the power storage device can be obtained. This is because as the viscosity of the electrolyte solution included in the power storage device is lower, the rate characteristics of the power storage device can be improved. Further, the number of carbon atoms in the alkyl group is preferably smaller so that the alicyclic quaternary ammonium cation can be easily synthesized.

As the anion included in the ionic liquid, a monovalent imide anion, a monovalent methide anion, a perfluoroalkyl sulfonic acid anion, tetrafluoroborate (BF₄⁻), and hexafluorophosphate (PF₆⁻) can be given. Example of a monovalent imide anion include (CₙF₂ₙ₊₁SO₂)₂N⁻ (n=0 to 3) and CF₂(CF₂SO₂)₂N⁻. As a monovalent methide anion, (CₙF₂ₙ₊₁SO₂)₂C⁻ (n=0 to 3), CF₂(CF₂SO₂)₂C⁻, and the like can be given. As a perfluoroalkyl sulfonic acid anion, (CₘF₂ₘ₊₁SO₃)⁻ (m=0 to 4) and the like can be given.

The freezing-point depressant contained in the nonaqueous solvent described in this embodiment is a substance (e.g., an organic salt or an inorganic salt) which can lower the freezing point of the ionic liquid by adding to the ionic liquid represented by the general formula (G1). Similarly to Embodiment 1, the freezing-point depressant is preferably an ionic liquid. For example, an ionic liquid including cyclic quaternary ammonium cation having an aliphatic or aromatic carbocyclic ring and its counter anion, and an ionic liquid including an acyclic quaternary ammonium cation and its counter anion can be used. In that case, the nonaqueous solvent according to one embodiment of the present invention contains a first ionic liquid and a second ionic liquid having different compound structures, and it can be said that the second ionic liquid functions as the freezing-point depressant.

Note that the mixture ratio of the ionic liquid represented by the general formula (G1) and the freezing-point depressant in the nonaqueous solvent described in this embodiment may be appropriately selected in consideration of kinds of the ionic liquid and the freezing-point depressant, or characteristics (viscosity, ion conductivity, and the like) needed for an electrolyte solution to be formed.

The nonaqueous solvent described in this embodiment may contain the first ionic liquid and the second ionic liquid which are represented by general formula (G1) and have different compound structures. In that case, it can be said that the second ionic liquid functions as the freezing-point depressant.

The freezing-point depressant may be the ionic liquid represented by the general formula (G2). In that case, the nonaqueous solvent described in this embodiment contains the ionic liquid represented by the general formula (G1) as the first ionic liquid and the ionic liquid represented by the general formula (G2) as the second ionic liquid, and it can be said that the second ionic liquid functions as the freezing-point depressant.

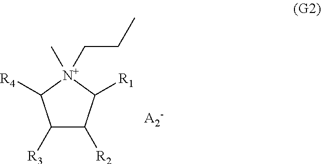

In the general formula (G2), R₁ to R₄ are individually any of a hydrogen atom, an alkyl group having 1 to 20 carbon atoms, a methoxy group, a methoxymethyl group, and a methoxyethyl group, and A₂⁻ is any of a monovalent imide anion, a monovalent methide anion, a perfluoroalkyl sulfonic acid anion, tetrafluoroborate (BF₄⁻), and hexafluorophosphate (PF₆⁻).

As described in Embodiment 1, the electrolyte solution (in particular, the nonaqueous solvent contained therein) included in the power storage device preferably has excellent reduction resistance and oxidation resistance (i.e., a wide potential window). The low reduction resistance of the ionic liquid contained in the electrolyte solution (in particular, the nonaqueous solvent contained therein) might result in decomposition of the ionic liquid and deterioration of characteristics of the power storage device, as described in Embodiment 1. Thus, when a cation having a positive charge, which is included in the ionic liquid, is particularly made difficult to accept electrons, the reduction potential of the ionic liquid can be lowered.

Thus, the ionic liquid (the first ionic liquid) contained in the nonaqueous solvent described in this embodiment also preferably has better reduction resistance than the freezing-point depressant. Specifically, the ionic liquid (the first ionic liquid) preferably has a plurality of electron donating substituents. This is because the reduction resistance of the ionic liquid tends to be improved as the number of the electron donating substituents increases in the ionic liquid, as described in Embodiment 1.

Further, the reduction potential of the ionic liquid contained in the nonaqueous solvent according to one embodiment of the present invention is preferably lower than oxidation-reduction potential of lithium (Li/Li⁺), which is a typical low potential negative electrode material.

However, as the number of electron donating substituents increases, the viscosity of the ionic liquid tends to increase.

Thus, the freezing-point depressant contained in the nonaqueous solvent described in embodiment also preferably has lower viscosity than the ionic liquid. In particular, in the case where an ionic liquid is used as the freezing-point depressant (that is, in the case where the nonaqueous solvent contains the first ionic liquid and the second ionic liquid), the viscosity of the second ionic liquid is preferably lower than that of the first ionic liquid. For example, in the case where R₁ to R₅ in the ionic liquid represented by the general formula (G2) are alkyl groups having 1 to 20 carbon atoms, the viscosity of an ionic liquid to be synthesized can be reduced with fewer carbon atoms (e.g., 1 to 4 carbon atoms). In this manner, the reduction resistance can be improved and the viscosity of the electrolyte solution (in particular, the nonaqueous solvent contained in the electrolyte solution) can be reduced to a much lower level than that of the first ionic liquid, so that a favorable electrolyte solution (in particular, the nonaqueous solvent contained in the electrolyte solution) included in the power storage device can be obtained. Note that the alicyclic quaternary ammonium cation included in the ionic liquid can be easily synthesized with fewer carbon atoms in the alkyl group.

The mixture ratio of the first ionic liquid and the second ionic liquid may be appropriately selected in consideration of characteristics (viscosity, ion conductivity, and the like) needed for an electrolyte solution to be formed.

Oxidation potential of the ionic liquid changes depending on anionic species. As described in Embodiment 1, the anion in the ionic liquid contained in the nonaqueous solvent described in this embodiment is preferably a monovalent anion selected from (CₙF₂ₙ₊₁SO₂)₂N⁻ (n=0 to 3), CF₂(CF₂SO₂)₂N⁻, and (CₘF₂ₘ₊₁SO₃)⁻ (m=0 to 4), whereby the oxidation potential of the ionic liquid can be increased (the oxidation resistance can be improved).

Here, the general formula (G5) to the general formula (G22) in accordance with the number of substituents in the ionic liquid represented by the general formula (G1) in the case where the ionic liquid represented by the general formula (G1) is used as the first ionic liquid and the ionic liquid represented by the general formula (G2) is used as the second ionic liquid are shown below. In the general formula (G5) to the general formula (G22), substituents that can be applied to R₁ to R₅ and an anion that can be applied to A₁⁻ are similar to those in the general formula (G1). Note that specific examples are not limited to the following general formula (G5) to the general formula (G22).

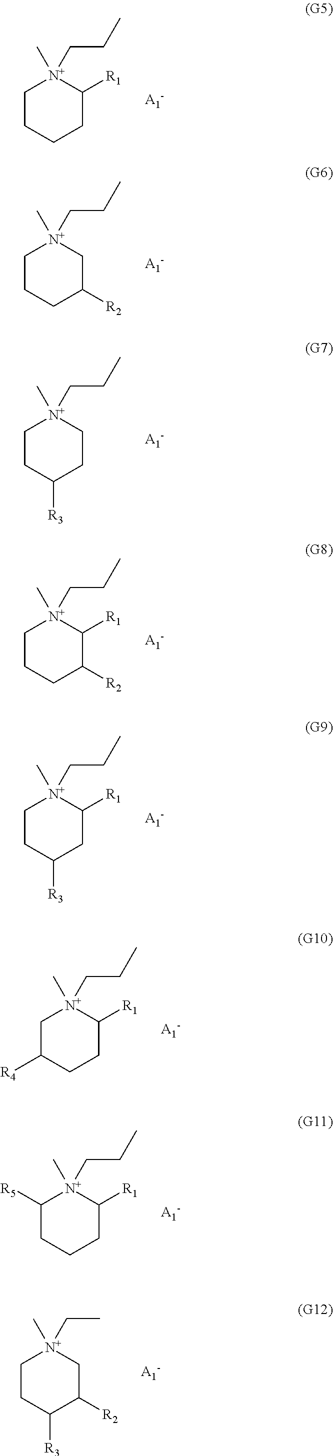

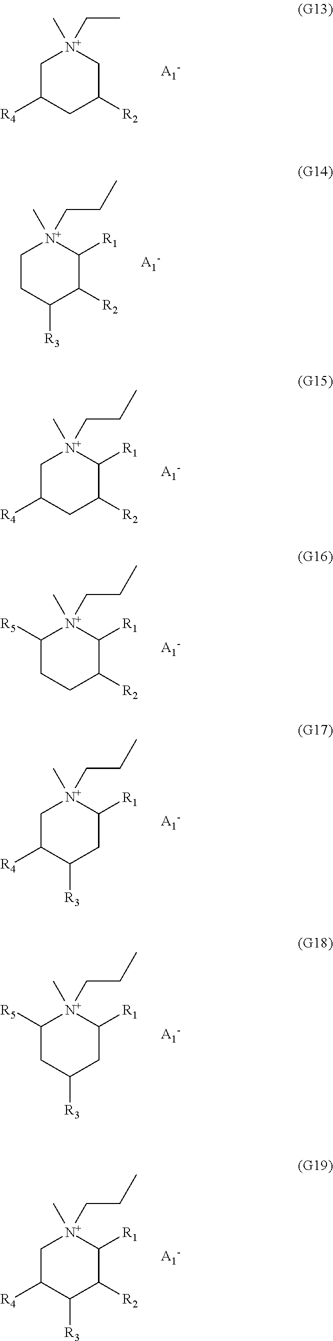

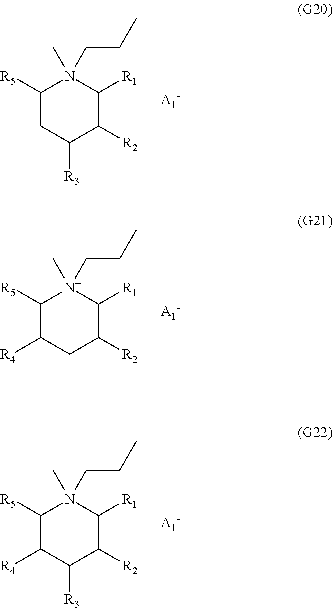

In addition, the general formula (G23) to the general formula (G31) which are specific examples of the ionic liquid represented by the general formula (G2) in accordance with the number of substituents are shown below. In the general formula (G23) to the general formula (G31), substituents that can be applied to R₁ to R₄ and an anion that can be applied to A₂⁻ are similar to those in the general formula (G2). Note that specific examples are not limited to the following general formula (G23) to the general formula (G31).

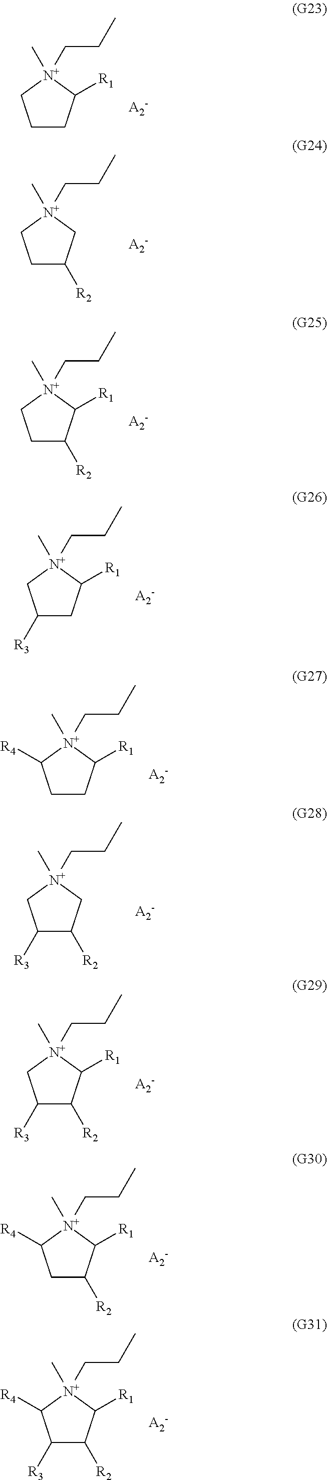

A preferable embodiment of the nonaqueous solvent described in this embodiment is a nonaqueous solvent containing the first ionic liquid having many electron donating substituents and excellent reduction resistance and oxidation resistance but high viscosity, and the second ionic liquid having reduction resistance inferior to the first ionic liquid but low viscosity.

Although each of the ionic liquid and the freezing-point depressant contained in the nonaqueous solvent described in this embodiment is one kind in the above description, the ionic liquid may be two or more kinds having different compound structures. In addition, the freezing-point depressant may also be two or more kinds having different compound structures.

For example, a mixture of one or more selected from the general formula (G5) to the general formula (G22) and one or more selected from the general formula (G23) to the general formula (G31) is one embodiment of the nonaqueous solvent described in this embodiment.

Accordingly, when reduction resistance and oxidation resistance of the nonaqueous solvent described in this embodiment are improved, that is, an oxidation-reduction potential window of the nonaqueous solvent is enlarged, the number of choices of positive electrode materials and negative electrode materials can be increased in a power storage device including the nonaqueous solvent; thus, the nonaqueous solvent is stable to a selected positive electrode material and negative electrode material. As a result, a power storage device having excellent reliability can be fabricated.

The energy density of a power storage device is caused by a difference between oxidation potential of a positive electrode material and reduction potential of a negative electrode material. Thus, a low potential negative electrode material and a high potential positive electrode material can be selected by using a nonaqueous solvent having a wide reduction-oxidation potential window, such as the nonaqueous solvent described in this embodiment. Consequently, a power storage device having high energy density can be fabricated.

### <Synthesis Method of Ionic Liquid Represented by General Formula (G1)>

Here, a method for synthesizing the ionic liquid described in this embodiment will be described. A variety of reactions can be applied to the method for synthesizing the ionic liquid described in this embodiment. For example, the ionic liquid represented by the general formula (G1) can be synthesized by a synthesis method described below. Here, an example is described referring to the synthesis scheme (S-1). Note that the method for synthesizing the ionic liquid described in this embodiment is not limited to the following synthesis method.

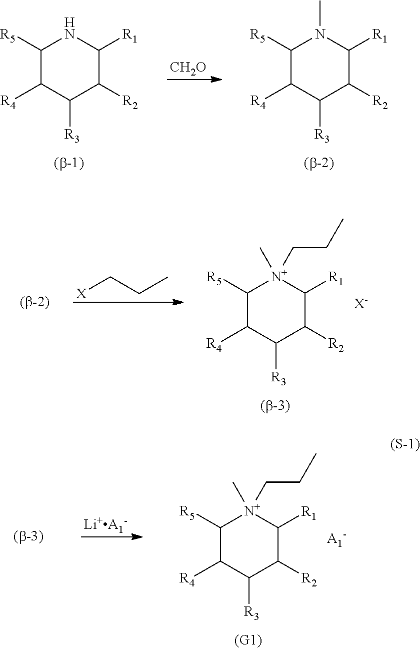

In the above scheme (S-1), the reaction from the general formula (β-1) to the general formula (β-2) is alkylation of amine by an amine compound and a carbonyl compound in the presence of hydride. For example, excessive formic acid can be used as the hydride source. Here, CH₂O is used as the carbonyl compound.

In the above scheme (S-1), the reaction from the general formula (β-2) to the general formula (β-3) is alkylation by a tertiary amine compound and an alkyl halide compound, which synthesizes a quaternary ammonium salt. Here, propane halide is used as the alkyl halide compound. Note that X represents halogen, and the halogen is preferably bromine or iodine, more preferably iodine, in terms of high reactivity.

Through ion exchange between the quaternary ammonium salt represented by the general formula (β-3) and a desired metal salt including A₁⁻, the ionic liquid represented by the general formula (G1) can be obtained. As the metal salt, a lithium metal salt can be used, for example

### <Synthesis Method of Ionic Liquid Represented by General Formula (G2)>

A variety of reactions can be applied to the ionic liquid represented by the general formula (G2). Here, an example is described referring to the synthesis scheme (S-2). Note that the method for synthesizing the ionic liquid described in this embodiment is not limited to the following synthesis method.

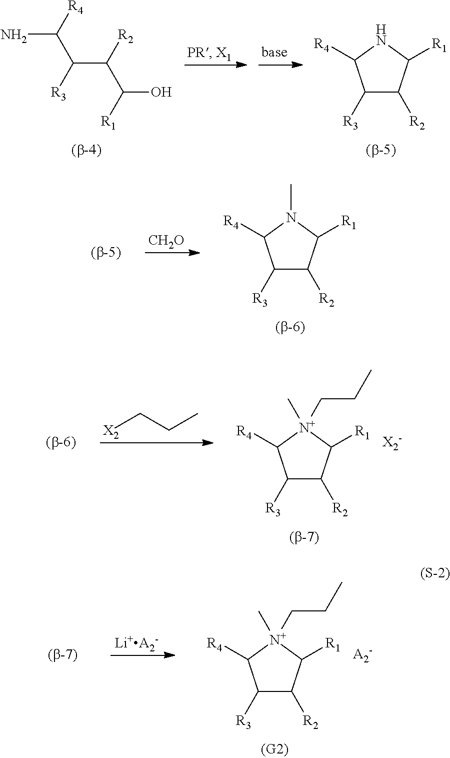

In the synthesis scheme (S-2), a reaction from the general formula (β-4) to the general formula (β-5) is a ring closure reaction of amino alcohol which passes through halogenation using a halogen source and trisubstituted phosphine such as trialkylphosphine. Note that PR′ represents trisubstituted phosphine and X₁ represents a halogen source. As the halogen source, carbon tetrachloride, carbon tetrabromide, iodine, or iodomethane can be used, for example. Here, triphenylphosphine is used as the trisubstituted phosphine and carbon tetrachloride is used as the halogen source.

In the above scheme (S-2), the reaction from the general formula (β-5) to the general formula (β-6) is alkylation of amine by an amine compound and a carbonyl compound in the presence of hydride. For example, excessive formic acid can be used as the hydride source. Here, CH₂O is used as the carbonyl compound.

In the above scheme (S-2), the reaction from the general formula (β-6) to the general formula (β-7) is alkylation by a tertiary amine compound and an alkyl halide compound, which synthesizes a quaternary ammonium salt. Here, propane halide is used as the alkyl halide compound. Further, X₂ represents halogen. The halogen is preferably bromine or iodine, more preferably iodine, in terms of high reactivity.

Through ion exchange between the quaternary ammonium salt represented by the general formula (β-7) and a desired metal salt including A₂⁻, the ionic liquid represented by the general formula (G2) can be obtained. As the metal salt, a lithium metal salt can be used, for example.

This embodiment can be implemented in appropriate combination with any of the structures described in the other embodiments.

### Embodiment 3

In this embodiment, a power storage device including the nonaqueous solvent according to one embodiment of the present invention will be described.

The power storage device according to one embodiment of the present invention includes at least a positive electrode, a negative electrode, a separator, and an electrolyte solution. The electrolyte solution contains the nonaqueous solvent described in the above embodiment and an electrolyte salt. The electrolyte salt is an electrolyte salt including carrier ions such as alkali metal ions, alkaline earth metal ions, beryllium ions, or manganese ions. Examples of the alkali metal ion include a lithium ion, a sodium ion, and potassium ion. Examples of the alkaline earth metal ion include a calcium ion, a strontium ion, and a barium ion. In this embodiment, the electrolyte salt is an electrolyte salt containing a lithium ion (hereinafter, referred to as a lithium-containing electrolyte salt).

With the above structure, the power storage device can be a lithium-ion secondary battery or a lithium ion capacitor. In the above structure, an electric double layer capacitor can be obtained by using only the ionic liquid according to one embodiment of the present invention for an electrolyte solution without using the electrolyte salt.

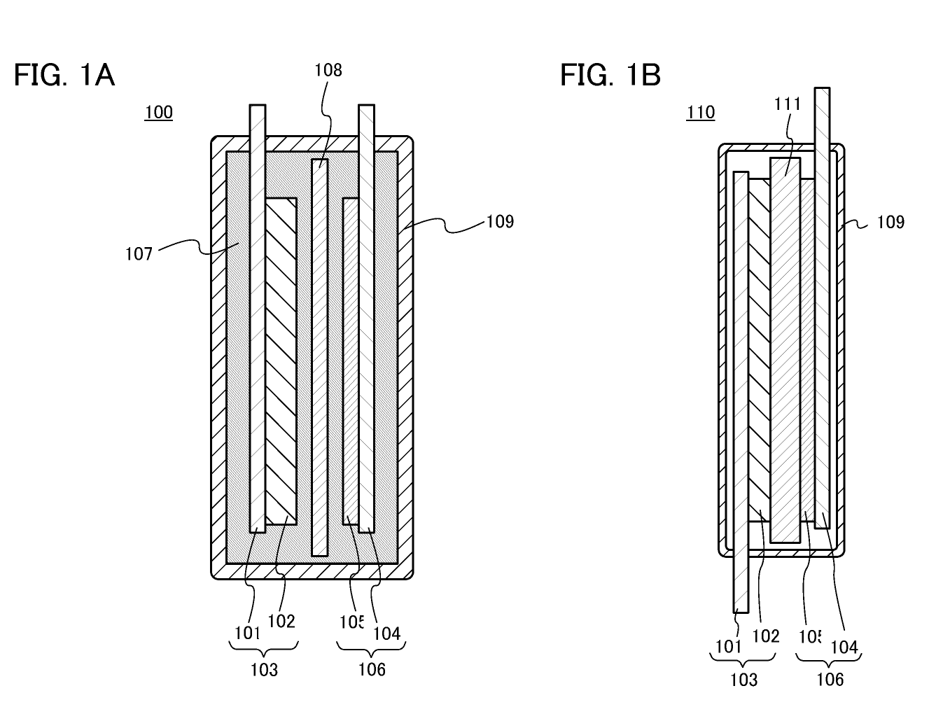

In this embodiment, a power storage device including an electrolyte solution containing the ionic liquid described in the above embodiment and a lithium-containing electrolyte salt and a method for manufacturing the power storage device will be described with reference to FIGS. 1A and 1B. The case where the power storage device is a lithium-ion secondary battery will be described below.

FIG. 1A illustrates an example of a structure of a power storage device 100. The power storage device 100 includes a positive electrode 103 including a positive electrode current collector 101 and a positive electrode active material layer 102, and a negative electrode 106 including a negative electrode current collector 104 and a negative electrode active material layer 105. Further, the power storage device 100 is a power storage device which includes a separator 108 between the positive electrode 103 and the negative electrode 106; a housing 109 in which the positive electrode 103, the negative electrode 106, and the separator 108 are provided; and an electrolyte solution 107 contained in the housing 109.

For the positive electrode current collector 101, a conductive material can be used, for example. Examples of the conductive material include aluminum (Al), copper (Cu), nickel (Ni), and titanium (Ti). In addition, an alloy material including two or more of the above-mentioned conductive materials can be used as the positive electrode current collector 101. Examples of the alloy material include an Al—Ni alloy and an Al—Cu alloy. Further, the positive electrode current collector 101 can be formed in such a manner that a conductive layer is formed separately over a substrate, and the conductive layer is separated from the substrate.

For the positive electrode active material layer 102, a material including ions to serve as carriers and a transition metal can be used, for example. As the material including ions to serve as carriers and a transition metal, a material represented by the general formula AₕMᵢPOⱼ (h>0, i>0, j>0) can be used, for example. Here, A represents, for example, an alkali metal such as lithium, sodium, or potassium; an alkaline earth metal such as calcium, strontium, or barium; beryllium; or magnesium. Further, M represents, for example, a transition metal such as iron, nickel, manganese, or cobalt. Examples of the material represented by the general formula AₕMᵢPOⱼ (h>0, i>0, j>0) include lithium iron phosphate and sodium iron phosphate. The material represented by A and the material represented by M may be selected from one or more of the above materials.

Alternatively, a material represented by the general formula AₕMᵢOⱼ (h>0, i>0, j>0) can be used. Here, A represents, for example, an alkali metal such as lithium, sodium, or potassium; an alkaline earth metal such as calcium, strontium, or barium; beryllium; or magnesium. M represents, for example, a transition metal such as iron, nickel, manganese, or cobalt. Examples of the material represented by the general formula AₕMᵢOⱼ (h>0, i>0, j>0) include lithium cobaltate, lithium manganate, and lithium nickelate. The material represented by A and the material represented by M may be selected from one or more of the above materials.

In this embodiment, since the power storage device 100 is a lithium-ion secondary battery, a material including lithium is preferably selected for the positive electrode active material layer 102. In other words, A in the above general formula AₕMᵢPOⱼ (h>0, i>0, j>0) or general formula AₕMᵢOⱼ (h>0, i>0, j>0) is preferably lithium.

The positive electrode active material layer 102 may be formed by application of a paste of a mixture of a positive electrode active material and a conductive auxiliary agent (e.g., acetylene black (AB)), a binder (e.g., polyvinylidene fluoride (PVDF)), and the like on the positive electrode current collector 101, or may be formed by a sputtering method.

Note that the conduction auxiliary agent may be an electron-conductive material which does not cause chemical change in the power storage device. For example, a carbon-based material such as graphite or carbon fiber; a metal material such as copper, nickel, aluminum, or silver; and powder, fiber, and the like of mixtures thereof can be given.

Examples of the binder include polysaccharides such as starch, carboxymethyl cellulose, hydroxypropyl cellulose, regenerated cellulose, and diacetyl cellulose; vinyl polymers such as polyvinyl chloride, polyvinyl pyrrolidone, polytetrafluoroethylene, polyvinylidene difluoride, polyethylene, polypropylene, ethylene-propylene-diene monomer (EPDM), sulfonated EPDM, styrene-butadiene rubber, butadiene rubber, and fluorine rubber; and polyether such as polyethylene oxide.

The positive electrode active material layer 102 may be formed using a paste of a mixture of the positive electrode active material and graphene or multilayer graphene instead of a conductive auxiliary agent and a binder. Note that in this specification, graphene refers to a one-atom-thick sheet of carbon molecules having sp² bonds. Further, multilayer graphene refers to a stack of 2 to 100 sheets of graphene. In graphene or multilayer graphene, the proportion of elements except hydrogen and carbon is preferably lower than or equal to 15 atomic %, or the proportion of elements except carbon is preferably lower than or equal to 30 atomic %. Note that graphene or multilayer graphene to which an alkali metal such as potassium is added may also be used.

With the use of graphene or multilayer graphene instead of a conductive auxiliary agent and a binder, as described above, the contents of a conductive auxiliary agent and a binder in the positive electrode 103 can be reduced. That is, the weight of the positive electrode 103 can be reduced. As a result, a capacity of a lithium-ion secondary battery per weight of an electrode can be increased.

Note that strictly speaking, an “active material” refers only to a material that relates to insertion and elimination of ions functioning as carriers. In this specification, however, in the case of using a coating method to form the positive electrode active material layer 102, for the sake of convenience, the positive electrode active material layer 102 collectively refers to the materials of the positive electrode active material layer 102, that is, a substance that is actually a “positive electrode active material”, and a conductive additive, a binder, or the like.

For the negative electrode current collector 104, a simple substance of copper (Cu), aluminum (Al), nickel (Ni), or titanium (Ti), or a compound of any of these elements can be used.

There is no particular limitation on a material used for the negative electrode active material layer 105 as long as it can dissolve and precipitate lithium and can be doped and dedoped with lithium ions. For example, a lithium metal, a carbon based material, silicon, a silicon alloy, or tin can be used. For carbon into/from which lithium ions can be inserted and extracted, graphite based carbon such as a fine graphite powder, a graphite fiber, or graphite can be used.

Note that the negative electrode active material layer 105 may be predoped with lithium. Predoping with lithium is performed in such a manner that a lithium layer is formed on a surface of the negative electrode active material layer 105 by a sputtering method. Alternatively, a lithium foil is provided on the surface of the negative electrode active material layer 105, whereby the negative electrode active material layer 105 can be predoped with lithium.

The surface of the negative electrode active material layer 105 may be formed using graphene or multilayer graphene. This makes it possible to reduce adverse effects (pulverization of the negative electrode active material layer 105 and separation of the negative electrode active material layer 105) of expansion and contraction of the negative electrode active material layer 105 due to dissolution/precipitation of lithium or doping/dedoping of lithium ions. Note that graphene or multilayer graphene can be formed on the surface of the negative electrode active material layer 105 in the following manner the negative electrode current collector 104 which is provided with the negative electrode active material layer 105 is soaked in a solution containing graphite or graphite oxide, and the solution is electrophoresed. A dip coating method using the solution can also be employed.

For the electrolyte solution 107, the ionic liquid described in the above embodiment is used for the nonaqueous solvent and a lithium-contained electrolyte salt is used as the electrolyte salt. Further, in the electrolyte solution 107, a nonaqueous solvent which dissolves the lithium-containing electrolyte salt is not limited to the nonaqueous solvent described in the above embodiment. For example, a mixed solvent in which one or both of another ionic liquid and another nonaqueous solvent is mixed into the nonaqueous solvent described in the above embodiment may be used.

As the electrolyte solution used for the power storage device has low reduction potential and high oxidation potential, that is, a wide oxidation-reduction potential window, the number of choices of materials used for a positive electrode and a negative electrode can be increased. Further, the electrolyte solution is stable to a selected positive electrode material and negative electrode material as the oxidation-reduction potential window is wide. With the use of the ionic liquid according to one embodiment of the present invention, which has a wide potential window, for a nonaqueous solvent in an electrolyte solution, the reliability of a lithium-ion secondary battery can be increased.

Examples of the lithium-containing electrolyte salt include lithium chloride (LiCl), lithium fluoride (LiF), lithium perchlorate (LiClO₄), lithium fluoroborate (LiBF₄), LiAsF₆, LiPF₆, and Li(CF₃SO₂)₂N. The electrolyte salt dissolved in the nonaqueous solvent described in the above embodiment is an electrolyte salt which includes carrier ions and corresponds with the positive electrode active material layer 102. In this embodiment, the lithium-containing electrolyte salt is used as the electrolyte salt because lithium is contained in the material used for the positive electrode active material layer 102. However, it is preferable to use an electrolyte salt containing sodium as the electrolyte salt when a material containing sodium is used for the positive electrode active material layer 102, for example. Note that the electrolyte salt is mixed into the nonaqueous solvent described in the above embodiment, whereby the freezing point is lowered. Accordingly, the electrolyte solution 107 further lowers the freezing point than the nonaqueous solvent described in the above embodiment. Thus, the power storage device including the electrolyte solution 107 can be operated in a low-temperature environment, that is, the operating temperature can be widened.

For the separator 108, paper; nonwoven fabric; a glass fiber; a synthetic fiber such as nylon (polyimide), vinylon (a polyvinyl alcohol based fiber), polyester, acrylic, polyolefin, or polyurethane; or the like may be used. Note that a material which does not dissolve in the electrolyte solution should be selected.

Specifically, as a material for the separator 108, high-molecular compounds based on fluorine-based polymer, polyether such as polyethylene oxide and polypropylene oxide, polyolefin such as polyethylene and polypropylene, polyacrylonitrile, polyvinylidene chloride, polymethyl methacrylate, polymethylacrylate, polyvinyl alcohol, polymethacrylonitrile, polyvinyl acetate, polyvinylpyrrolidone, polyethyleneimine, polybutadiene, polystyrene, polyisoprene, and polyurethane, derivatives thereof, cellulose, paper, nonwoven fabric, and a glass fiber can be used either alone or in combination.

Next, a power storage device 110, which has a different structure from the power storage device 100 illustrated in FIG. 1A, will be described with reference to FIG. 1B. The power storage device 110 illustrated in FIG. 1B includes the positive electrode 103 including the positive electrode current collector 101 and the positive electrode active material layer 102, the negative electrode 106 including the negative electrode current collector 104 and the negative electrode active material layer 105, a separator 111, an electrolyte solution, and the housing 109, which is similar to the power storage device 100. The separator 111 is provided between the positive electrode 103 and the negative electrode 106, and includes the electrolyte solution.

The negative electrode current collector 104, the negative electrode active material layer 105, the positive electrode current collector 101, and the positive electrode active material layer 102 illustrated in FIG. 1B are similar to those in the power storage device 100.

The separator 111 is preferably a porous film. As a material of the porous film, a glass fiber, a synthetic resin material, a ceramic material, or the like may be used.

The electrolyte solution included in the separator 111 is similar to the electrolyte solution 107 described in the power storage device 100.

Here, a method for manufacturing the power storage device according to one embodiment of the present invention will be described. First, a method for manufacturing the positive electrode 103 including the positive electrode active material layer 102 over the positive electrode current collector 101 will be described.

Materials for the positive electrode current collector 101 and the positive electrode active material layer 102 are selected from the above-described materials.

The positive electrode active material layer 102 is formed over the positive electrode current collector 101. The positive electrode active material layer 102 may be formed by a coating method or a sputtering method. In the case of forming the positive electrode active material layer 102 by a coating method, the material for the positive electrode active material layer 102 is mixed with a conduction auxiliary agent, a binder, and the like to form a paste, and the paste is applied onto the positive electrode current collector 101 and dried to form the positive electrode active material layer 102. In the case of forming the positive electrode active material layer 102 by a coating method, pressure forming may be employed, if necessary. In the above manner, the positive electrode 103 in which the positive electrode active material layer 102 is formed over the positive electrode current collector 101 is formed.

Next, a method for manufacturing the negative electrode 106 including the negative electrode current collector 104 and the negative electrode active material layer 105 will be described.

Materials for the negative electrode current collector 104 and the negative electrode active material layer 105 are selected from the above-described materials the above described materials.

The negative electrode active material layer 105 is formed over the negative electrode current collector 104. In this embodiment, a lithium foil is used. The ionic liquid described in the above embodiment is excellent in reduction resistance and is stable to lithium which is a negative electrode material having the lowest potential. Consequently, when the ionic liquid is used for the nonaqueous solvent in the electrolyte solution, the lithium-ion secondary battery which has high energy density and excellent reliability can be obtained.

In the case where a material other than a lithium foil is used for the negative electrode active material layer 105, the negative electrode active material layer 105 can be formed in a manner similar to that of the positive electrode active material layer 102. For example, when silicon is used for the negative electrode active material layer 105, a material obtained by forming microcrystalline silicon over the negative electrode current collector 104 and then removing amorphous silicon from the microcrystalline silicon by etching may be used. When amorphous silicon is removed from microcrystalline silicon, the surface area of the remaining microcrystalline silicon is increased. A chemical vapor deposition method or a physical vapor deposition method can be used as the deposition method of the microcrystalline silicon. For example, a plasma CVD method can be used as the chemical vapor deposition method and a sputtering method can be used as the physical vapor deposition method. Note that in the case where a conductive auxiliary agent and a binder are used for the negative electrode 106, a material selected from the above-described materials can be used as appropriate.

The electrolyte solution 107 and the electrolyte solution included in the separator 111 can be formed as follows: an ionic liquid is synthesized by the method described in the above embodiment, and an electrolyte salt containing carrier ions is mixed into the ionic liquid. In this embodiment, Li (CF₃SO₂)₂N is used as a lithium-containing electrolyte salt and is mixed into the ionic liquid.

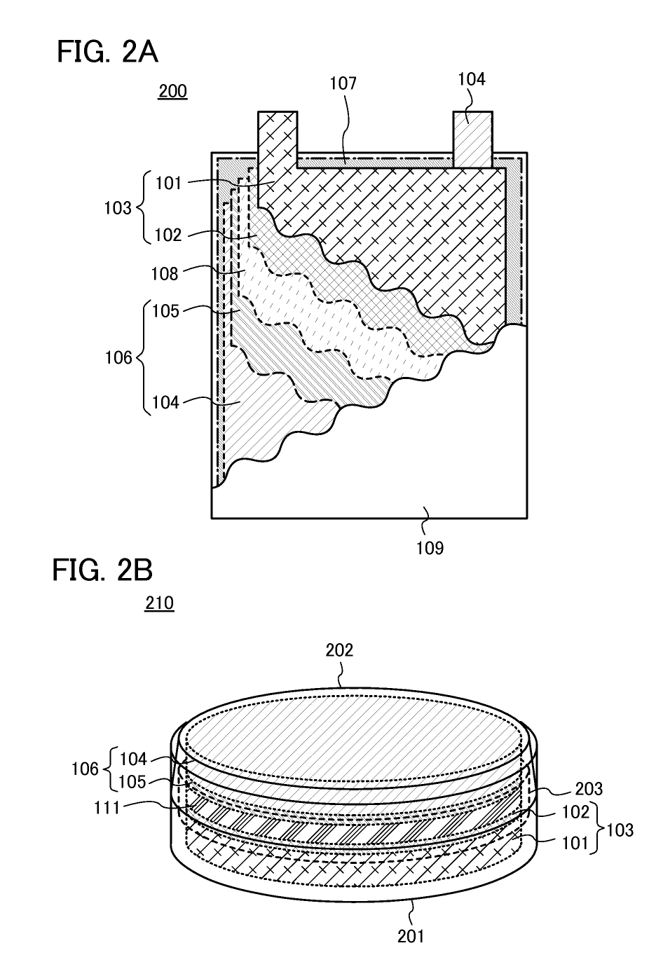

Next, a top view of a specific structure of a power storage device in which the power storage device 100 in FIG. 1A is laminated is illustrated in FIG. 2A.

A laminated power storage device 200 illustrated in FIG. 2A includes the positive electrode 103 including the positive electrode current collector 101 and the positive electrode active material layer 102 and the negative electrode 106 including the negative electrode current collector 104 and the negative electrode active material layer 105, which are described above. Further, the laminated power storage device 200 illustrated in FIG. 2A includes the separator 108 between the positive electrode 103 and the negative electrode 106. That is, the laminated power storage device 200 is a power storage device in which the positive electrode 103, the negative electrode 106, and the separator 108 are placed inside the housing 109 and the electrolyte solution 107 is provided inside the housing 109.

In FIG. 2A, the negative electrode current collector 104, the negative electrode active material layer 105, the separator 108, the positive electrode active material layer 102, and the positive electrode current collector 101 are arranged in this order from the bottom side. The negative electrode current collector 104, the negative electrode active material layer 105, the separator 108, the positive electrode active material layer 102, and the positive electrode current collector 101 are provided in the housing 109. The housing 109 is filled with the electrolyte solution 107.

The positive electrode current collector 101 and the negative electrode current collector 104 in FIG. 2A also function as terminals for electrical contact with the outside. For this reason, part of each of the positive electrode current collector 101 and the negative electrode current collector 104 is arranged outside the housing 109 so as to be exposed.

Note that the structure of the laminated power storage device 200 is not limited to the structure illustrated in FIG. 2A and may be another structure.

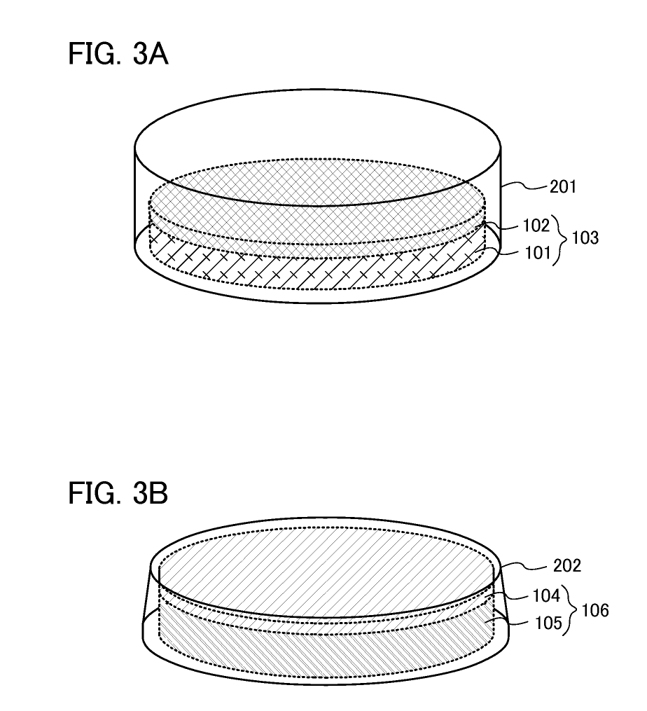

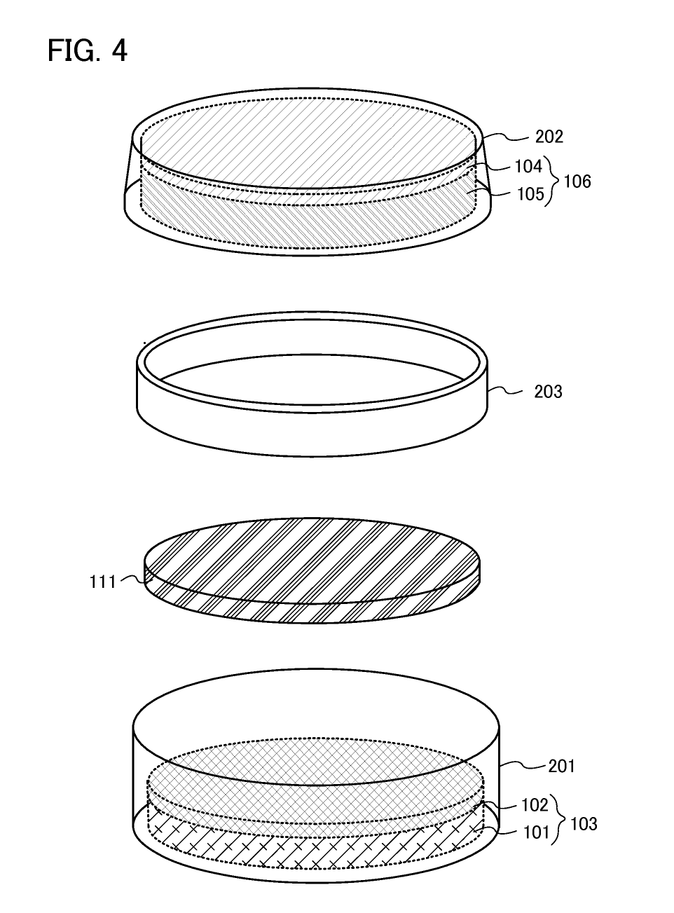

Next, a perspective view of a specific structure of a power storage device in which the power storage device 110 in FIG. 1B is a button type is illustrated in FIG. 2B. The specific structure and a method for assembling a button power storage device 210 illustrated in FIG. 2B will be described with reference to FIGS. 3A and 3B and FIG. 4.

The button power storage device 210 illustrated in FIG. 2B includes the separator 111 which is provided between the positive electrode 103 and the negative electrode 106 and includes an electrolyte solution.

First, a first housing 201 is prepared. The bottom surface of the first housing 201 is a circle and the side view of the first housing 201 is a rectangle. That is, the first housing 201 is a dish having a columnar shape. It is necessary to use a conductive material for the first housing 201 in order that the positive electrode 103 can be electrically connected to the outside. For example, the first housing 201 may be formed of a metal material. The positive electrode 103 including the positive electrode current collector 101 and the positive electrode active material layer 102 is provided in the first housing 201 (see FIG. 3A).

Then, a second housing 202 is prepared. The bottom surface of the second housing 202 is a circle and the side view of the second housing 202 is a trapezoid in which the lower base is longer than the upper base. That is, the second housing 202 is a dish having a columnar shape. The diameter of the dish is smallest at the top and increases downward. Note that diameters of the top surface and the bottom surface of the second housing 202 are smaller than the diameter of the bottom surface of the first housing 201. The reason will be described later.

It is necessary to use a conductive material for the second housing 202 in order that the negative electrode 106 can be electrically connected to the outside. For example, the second housing 202 may be formed of a metal material. The negative electrode 106 including the negative electrode current collector 104 and the negative electrode active material layer 105 is provided in the second housing 202.

A ring-shaped insulator 203 is provided so as to surround the side of the positive electrode 103 provided in the first housing 201 (see FIG. 4). The ring-shaped insulator 203 has a function of insulating the negative electrode 106 and the positive electrode 103 from each other. The ring-shaped insulator 203 is preferably formed using an insulating resin.

The second housing 202 in which the negative electrode 106 is provided as shown in FIG. 3B is installed in the first housing 201 in which the ring-shaped insulator 203 is provided, with the separator 111 which is already impregnated with the electrolyte solution provided therebetween (see FIG. 4). The second housing 202 can be fit in the first housing 201 because the diameters of the top surface and the bottom surface of the second housing 202 are smaller than the diameter of the bottom surface of the first housing 201 (see FIG. 4).

As described above, the positive electrode 103 and the negative electrode 106 are insulated from each other by the ring-shaped insulator 203, so that a short circuit does not occur.

Note that the structure of the button power storage device 210 is not limited to the structure illustrated in FIG. 2B and may be another structure. For example, a member such as a spacer or a washer can be used as appropriate.

Although the structures of the lithium-ion secondary battery and the manufacturing methods thereof are described with reference to FIGS. 1A and 1B, FIGS. 2A and 2B, FIGS. 3A and 3B, and FIG. 4, the power storage device according to one embodiment of the present invention is not limited thereto. A capacitor can be formed using at least a positive electrode, a negative electrode, a separator, and the nonaqueous solvent according to one embodiment of the present invention. For example, an electric double layer capacitor in which the nonaqueous solvent is used for an electrolyte solution, or a lithium ion capacitor in which the nonaqueous solvent and a lithium-containing electrolyte salt are used for an electrolyte solution can be used.

In the case where the power storage devices 100, 110, 200, and 210 are used as lithium ion capacitors, a material into/from which lithium ions and/or anions can be reversibly absorbed (inserted)/extracted may be used for the positive electrode active material layer 102. For the positive electrode active material layer 102 and the negative electrode active material layer 105, for example, active carbon, graphite, a conductive polymer, or a polyacene organic semiconductor (PAS) can be used.

The nonaqueous solvent according to one embodiment of the present invention has a wide potential window and high electrochemical stability, and thus is stable to the selected positive electrode material or negative electrode material. Thus, with the use of the nonaqueous solvent according to one embodiment of the present invention for an electrolyte solution of a lithium ion capacitor, the reliability of the lithium ion capacitor can be increased.

Since the nonaqueous solvent according to one embodiment of the present invention has a low freezing point, a lithium ion capacitor having a wide range of operating temperature where the capacitor can be operated in a low-temperature environment can be fabricated by using the nonaqueous solvent as a nonaqueous solvent in an electrolyte solution in a lithium ion capacitor.

In the case where the power storage devices 100, 110, 200, and 210 are used as electric double layer capacitors, for the positive electrode active material layer 102 and the negative electrode active material layer 105, for example, active carbon, graphite, a conductive polymer, or a polyacene organic semiconductor (PAS) can be used.

In the case where the power storage device described in this specification is used as an electric double layer capacitor, an electrolyte solution can be formed using only the nonaqueous solvent according to one embodiment of the present invention.

The nonaqueous solvent according to one embodiment of the present invention has a wide potential window and high electrochemical stability, and thus is stable to the selected positive electrode material or negative electrode material. Thus, with the use of the nonaqueous solvent according to one embodiment of the present invention for an electrolyte solution of an electric double layer capacitor, the reliability of the electric double layer capacitor can be increased.

Since the nonaqueous solvent according to one embodiment of the present invention has a low freezing point, an electric double layer capacitor having a wide range of operating temperature where the capacitor can be operated in a low-temperature environment can be fabricated by using the nonaqueous solvent as a nonaqueous solvent in an electrolyte solution in an electric double layer capacitor.

Although examples of a laminated power storage device and a button power storage device are described in this embodiment, the power storage device according to one embodiment of the present invention is not limited thereto. A variety of structures can be employed for the power storage device; for example, a stack type power storage device or a cylinder-type power storage device can be manufactured.

As described above, the power storage device can have high energy density, high reliability, and high performance according to this embodiment.

This embodiment can be implemented in appropriate combination with any of the structures described in the other embodiments.

### Embodiment 4

A power storage device according to one embodiment of the present invention can be used as a power supply of a variety of electric appliances which are driven by electric power.

Specific examples of electric appliances using the power storage device according to one embodiment of the present invention are as follows: display devices, lighting devices, desktop personal computers or notebook computers, image reproduction devices which reproduce a still image or a moving image stored in a recording medium such as a digital versatile disc (DVD), mobile phones, portable game machines, portable information terminals, e-book readers, video cameras, digital still cameras, high-frequency heating apparatus such as microwaves, electric rice cookers, electric washing machines, air-conditioning systems such as air conditioners, electric refrigerators, electric freezers, electric refrigerator-freezers, freezers for preserving DNA, dialysis devices, and the like. In addition, moving objects driven by an electric motor using electric power from a power storage device are also included in the category of electric appliances. As examples of the moving objects, electric vehicles, hybrid vehicles which include both an internal-combustion engine and a motor, and motorized bicycles including motor-assisted bicycles can be given.

In the electric appliances, the power storage device according to one embodiment of the present invention can be used as a power storage device for supplying enough electric power for almost the whole power consumption (such a power storage device is referred to as a main power supply). Alternatively, in the electric appliances, the power storage device according to one embodiment of the present invention can be used as a power storage device which can supply electric power to the electric appliances when the supply of power from the main power supply or a commercial power supply is stopped (such a power storage device is referred to as an uninterruptible power supply). Further alternatively, in the electric appliances, the power storage device according to one embodiment of the present invention can be used as a power storage device for supplying electric power to the electric appliances at the same time as the electric power supply from the main power supply or a commercial power supply (such a power storage device is referred to as an auxiliary power supply).

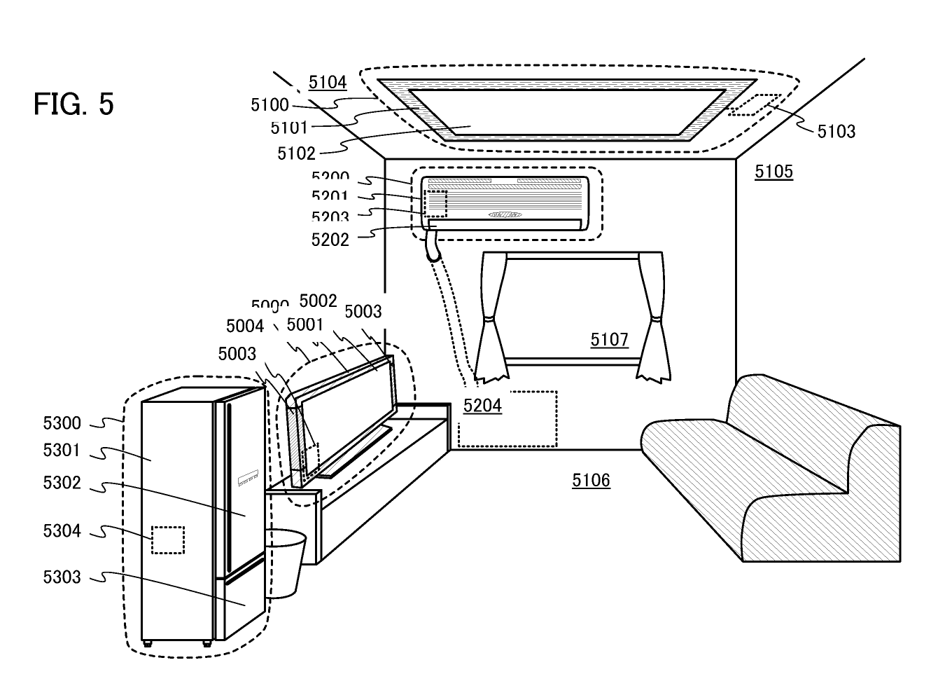

FIG. 5 shows specific structures of the electric appliances. In FIG. 5, a display device 5000 is an example of an electric appliance including a power storage device 5004 according to one embodiment of the present invention. Specifically, the display device 5000 corresponds to a display device for TV broadcast reception and includes a housing 5001, a display portion 5002, speaker portions 5003, the power storage device 5004, and the like. The power storage device 5004 according to one embodiment of the present invention is provided inside the housing 5001. The display device 5000 can receive electric power from a commercial power supply. Alternatively, the display device 5000 can use electric power stored in the power storage device 5004. Thus, the display device 5000 can be operated with the use of the power storage device 5004 according to one embodiment of the present invention as an uninterruptible power supply even when electric power cannot be supplied from the commercial power supply due to power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), a field emission display (FED), and the like can be used for the display portion 5002.

Note that the display device includes, in its category, all of information display devices for personal computers, advertisement displays, and the like other than TV broadcast reception.

In FIG. 5, an installation lighting device 5100 is an example of an electric appliance including a power storage device 5103 according to one embodiment of the present invention. Specifically, the lighting device 5100 includes a housing 5101, a light source 5102, the power storage device 5103, and the like. FIG. 5 shows the case where the power storage device 5103 is provided in a ceiling 5104 on which the housing 5101 and the light source 5102 are installed; alternatively, the power storage device 5103 may be provided in the housing 5101. The lighting device 5100 can receive electric power from the commercial power supply. Alternatively, the lighting device 5100 can use electric power stored in the power storage device 5103. Thus, the lighting device 5100 can be operated with the use of the power storage device 5103 according to one embodiment of the present invention as an uninterruptible power supply even when electric power cannot be supplied from the commercial power supply because of power failure or the like.

Note that although the installation lighting device 5100 provided in the ceiling 5104 is shown in FIG. 5 as an example, the power storage device according to one embodiment of the present invention can be used in an installation lighting device provided in, for example, a wall 5105, a floor 5106, a window 5107, or the like other than the ceiling 5104. Alternatively, the power storage device can be used in a tabletop lighting device and the like.

As the light source 5102, an artificial light source which provides light artificially by using electric power can be used. Specifically, a discharge lamp such as an incandescent lamp and a fluorescent lamp, and a light-emitting element such as an LED and an organic EL element are given as examples of the artificial light source.

In FIG. 5, an air conditioner including an indoor unit 5200 and an outdoor unit 5204 is an example of an electric appliance including a power storage device 5203 according to one embodiment of the present invention. Specifically, the indoor unit 5200 includes a housing 5201, a ventilation duct 5202, the power storage device 5203, and the like. FIG. 5 shows the case where the power storage device 5203 is provided in the indoor unit 5200; alternatively, the power storage device 5203 may be provided in the outdoor unit 5204. Further alternatively, the power storage device 5203 may be provided in both the indoor unit 5200 and the outdoor unit 5204. The air conditioner can receive electric power from the commercial power supply. Alternatively, the air conditioner can use electric power stored in the power storage device 5203. Specifically, in the case where the power storage devices 5203 are provided n both the indoor unit 5200 and the outdoor unit 5204, the air conditioner can be operated with the use of the power storage device 5203 according to one embodiment of the present invention as an uninterruptible power supply even when electric power cannot be supplied from the commercial power supply due to power failure or the like.

Note that although the separated air conditioner including the indoor unit and the outdoor unit is shown in FIG. 5 as an example, the power storage device according to one embodiment of the present invention can be used in an air conditioner in which the functions of an indoor unit and an outdoor unit are integrated in one housing.

In FIG. 5, an electric refrigerator-freezer 5300 is an example of an electric appliance including a power storage device 5304 according to one embodiment of the present invention. Specifically, the electric refrigerator-freezer 5300 includes a housing 5301, a door for a refrigerator 5302, a door for a freezer 5303, and the power storage device 5304. The power storage device 5304 is provided in the housing 5301 in FIG. 5. Alternatively, the electric refrigerator-freezer 5300 can receive electric power from the commercial power supply or can use power stored in the power storage device 5304. Thus, the electric refrigerator-freezer 5300 can be operated with the use of the power storage device 5304 according to one embodiment of the present invention as an uninterruptible power supply even when electric power cannot be supplied from the commercial power supply because of power failure or the like.

Note that among the electric appliances described above, a high-frequency heating apparatus such as a microwave and an electric appliance such as an electric rice cooker require high electric power in a short time. The tripping of a circuit breaker of a commercial power supply in use of electric appliances can be prevented by using the power storage device according to one embodiment of the present invention as an auxiliary power supply for supplying electric power which cannot be supplied enough by a commercial power supply.

In addition, in a time period when electric appliances are not used, specifically when the proportion of the amount of power which is actually used to the total amount of power which can be supplied by a commercial power supply source (such a proportion referred to as usage rate of power) is low, power can be stored in the power storage device, whereby the usage rate of power can be reduced in a time period when the electric appliances are used. In the case of the electric refrigerator-freezer 5300, electric power can be stored in the power storage device 5304 at night time when the temperature is low and the door for a refrigerator 5302 and the door for a freezer 5303 are not opened and closed. The power storage device 5304 is used as an auxiliary power supply in daytime when the temperature is high and the door for a refrigerator 5302 and the door for a freezer 5303 are opened and closed; thus, the usage rate of electric power in daytime can be reduced.

This embodiment can be implemented in appropriate combination with any of the structures described in the other embodiments.

This application is based on Japanese Patent Application serial no. 2011-140733 filed with Japan Patent Office on Jun. 24, 2011, the entire contents of which are hereby incorporated by reference.

What is claimed is:

1. A solvent comprising:
an ionic liquid comprising an alicyclic quaternary ammonium cation having one or more substituents and a counter anion to the alicyclic quaternary ammonium cation; and
a freezing-point depressant.

2. The solvent according to claim 1, wherein the substituent is bonded to an aliphatic ring of the alicyclic quaternary ammonium cation.

3. The solvent according to claim 1, wherein the number of carbon atoms in the aliphatic ring of the alicyclic quaternary ammonium cation is five or less.

4. The solvent according to claim 1, wherein the freezing-point depressant has lower viscosity than the ionic liquid.

5. The solvent according to claim 1, wherein the freezing-point depressant is an ionic liquid comprising an alicyclic quaternary ammonium cation and a counter anion to the alicyclic quaternary ammonium cation.

6. The solvent according to claim 1, wherein the freezing-point depressant is an ionic liquid comprising an acyclic quaternary ammonium cation and a counter anion to the acyclic quaternary ammonium cation.

7. The solvent according to claim 1, wherein the solvent is a nonaqueous solvent.

8. A power storage device comprising:
a positive electrode;
a negative electrode;
an electrolyte solution; and
a separator,
wherein the electrolyte solution contains the solvent according to claim 1.

9. A power storage device comprising:
a positive electrode;
a negative electrode;
an electrolyte solution; and
a separator,
wherein the electrolyte solution contains the solvent according to claim 1 and an electrolyte salt containing a lithium ion.

10. A solvent comprising:
an ionic liquid represented by a general formula (G1); and
a freezing-point depressant, 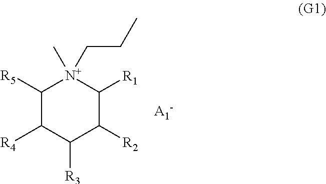
wherein R₁ to R₅ are individually selected from a hydrogen atom, an alkyl group having 1 to 20 carbon atoms, a methoxy group, a methoxymethyl group, and a methoxyethyl group, and
wherein A₁⁻ is selected from any of a monovalent imide anion, a monovalent methide anion, a perfluoroalkyl sulfonic acid anion, tetrafluoroborate, and hexafluorophosphate.

11. The solvent according to claim 10, wherein the freezing-point depressant has lower viscosity than the ionic liquid represented by the general formula (G1).

12. The solvent according to claim 10, wherein the freezing-point depressant is an ionic liquid comprising an alicyclic quaternary ammonium cation and a counter anion to the alicyclic quaternary ammonium cation.

13. The solvent according to claim 10, wherein the freezing-point depressant is an ionic liquid comprising an acyclic quaternary ammonium cation and a counter anion to the acyclic quaternary ammonium cation.

14. The solvent according to claim 10, wherein the freezing-point depressant is the ionic liquid represented by the general formula (G1).

15. The solvent according to claim 10,
wherein the freezing-point depressant is an ionic liquid represented by a general formula (G2), 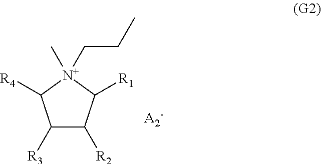
wherein R₁ to R₄ are individually selected from any of a hydrogen atom, an alkyl group having 1 to 20 carbon atoms, a methoxy group, a methoxymethyl group, and a methoxyethyl group, and
wherein A₂⁻ is selected from any of a monovalent imide anion, a monovalent methide anion, a perfluoroalkyl sulfonic acid anion, tetrafluoroborate, and hexafluorophosphate.

16. The solvent according to claim 10, wherein the solvent is a nonaqueous solvent.

17. A power storage device comprising:
a positive electrode;
a negative electrode;
an electrolyte solution; and
a separator,
wherein the electrolyte solution contains the solvent according to claim 10.

18. A power storage device comprising:
a positive electrode;
a negative electrode;
an electrolyte solution; and
a separator,
wherein the electrolyte solution contains the solvent according to claim 10 and an electrolyte salt containing a lithium ion.
